(19) United States
(12) Patent Application Publication
(10) Pub. No.: US 2011/0130517 A1
(43) Pub. Date: Jun. 2, 2011

(54) Hydrolytic stability of polycarbonate containing rubber modifier

(75) Inventor: Xiangyang Li, Seven Fields, PA (US)

(73) Assignee: Bayer MaterialScience LLC, Pittsburgh, PA (US)

(21) Appl. No.: 12/592,713

(22) Filed: Dec. 1, 2009

(51) Int. Cl. C08L 51/00

(52) U.S. Cl. 525/64

(57) ABSTRACT

The present invention provides a thermoplastic molding composition containing an aromatic polycarbonate and a core-shell graft copolymer which is coagulated with a salt of a metal element selected from the group consisting of lithium, sodium, potassium, rubidium, cesium, francium, beryllium, magnesium, calcium, strontium, barium and radium. The molding composition may optionally include a polyalkylene terephthalate. The inventive thermoplastic molding composition exhibits improved hydrolytic stability over a comparable thermoplastic molding composition produced with a core shell graft copolymer coagulated with a salt of a metal element not selected from the group consisting of lithium, sodium, potassium, rubidium, cesium, francium, beryllium, magnesium, calcium, strontium, barium and radium.

### FIELD OF THE INVENTION

The present invention relates in general to, thermoplastic molding compositions and in particular to an impact-modified polycarbonate composition having improved hydrolytic stability.

### BACKGROUND OF THE INVENTION

U.S. Pat. No. 6,777,492 issued to Nakai et al., discloses a graft copolymer which is prepared by emulsion graft polymerization of a rubber polymer containing 0-50% by weight of a butadiene unit and 50-100% by weight of a (meth)acrylate unit and at least one monomer selected from aromatic alkenyl compound, methacrylate, acrylate and vinyl cyanide compound. The graft copolymer of Nakai et al., contains 0.5-2.0% by weight of an emulsifier residue. The thermoplastic resin composition containing the graft copolymer is said to cause less gas evolution during the molding, provide a molded article with good gloss of molding, and have excellent weather resistance, impact resistance and fluidity.

A need continues to exist in the art for thermoplastic molding compositions with improved hydrolytic stability.

### SUMMARY OF THE INVENTION

Accordingly, the present invention provides a thermoplastic molding composition containing an aromatic polycarbonate and a core-shell graft copolymer which is coagulated with a salt of a metal element selected from the group consisting of lithium, sodium, potassium, rubidium, cesium, francium, beryllium, magnesium, calcium, strontium, barium and radium. The molding composition may optionally include a polyalkylene terephthalate. The inventive thermoplastic molding composition exhibits improved hydrolytic stability over a comparable thermoplastic molding composition produced with a core shell graft copolymer coagulated with a salt of a metal element not selected from the group consisting of lithium, sodium, potassium, rubidium, cesium, francium, beryllium, magnesium, calcium, strontium, barium and radium.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a thermoplastic molding composition containing (a) an aromatic polycarbonate, and (b) a core-shell graft copolymer which is coagulated with a salt of a metal element selected from the group consisting of lithium, sodium, potassium, rubidium, cesium, francium, beryllium, magnesium, calcium, strontium, barium and radium, (c) optionally, a polyalkylene terephthalate, wherein the thermoplastic molding composition exhibits improved hydrolytic stability over a comparable thermoplastic molding composition produced with a core shell graft copolymer coagulated with a salt of a metal element other than lithium, sodium, potassium, rubidium, cesium, francium, beryllium, magnesium, calcium, strontium, barium and radium.

The present invention further provides a process for the production of a thermoplastic molding composition having improved hydrolytic stability, the process involving combining (a) an aromatic polycarbonate; and (b) a core-shell graft copolymer which is coagulated with a salt of a metal element selected from the group consisting of lithium, sodium, potassium, rubidium, cesium, francium, beryllium, magnesium, calcium, strontium, barium and radium, (c) optionally, a polyalkylene terephthalate, wherein the improved hydrolytic stability is over a comparable thermoplastic molding composition produced with a core shell graft copolymer coagulated with a salt of a metal element other than lithium, sodium, potassium, rubidium, cesium, francium, beryllium, magnesium, calcium, strontium, barium and radium.

### Aromatic Polycarbonate

The term aromatic polycarbonates as used in the present context, refers generically to homopolycarbonates, and to copolycarbonates, including polyestercarbonates. These materials are well known and are available in commerce. Aromatic polycarbonates may be prepared by known processes including melt transesterification process and interfacial polycondensation process (See, e.g., Schnell's “Chemistry and Physics of Polycarbonates”, Interscience Publishers, 1964) and are widely available in commerce, for instance under the MAKROLON name from Bayer MaterialScience.

Aromatic dihydroxy compounds suitable for the preparation of aromatic polycarbonates conform to formula (I):

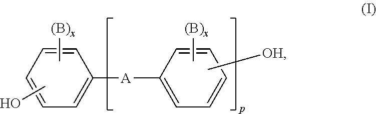

wherein
A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed other aromatic rings optionally containing hetero atoms, or a radical conforming to formula (II) or (III):

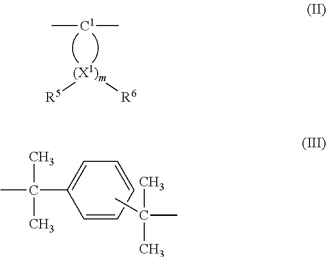

The substituents B independently denote C₁- to C₁₂-alkyl, preferably methyl, x independently denote 0, 1 or 2, p represents 1 or 0, and R⁵ and R⁶ are selected individually for each X¹ and each independently of the other denote hydrogen or C₁- to C₆-alkyl, preferably hydrogen, methyl or ethyl, X¹ represents carbon, and m represents an integer of 4 to 7, preferably 4 or 5, with the proviso that on at least one atom X¹, R⁵ and R⁶ are both alkyl groups.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl) sulfoxides, bis-(hydroxyphenyl) ketones, bis-(hydroxyphenyl)-sulfones and α,α-bis-(hydroxyphenyl)-diisopropyl-benzenes. Particularly preferred aromatic dihydroxy compounds are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl-sulfone. Special preference is given to 2,2-bis-(4-hydroxyphenyl)-propane (bisphenol A). These compounds may be used singly or as mixtures containing two or more aromatic dihydroxy compounds.

Chain terminators suitable for the preparation of polycarbonates include phenol, p-chlorophenol, p-tert.-butylphenol, as well as long-chained alkylphenols, such as 4-(1,3-tetramethylbutyl)-phenol or monoalkylphenols or dialkylphenols having a total of from 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)-phenol and 4-(3,5-dimethylheptyl)-phenol. The amount of chain terminators to be used is preferably 0.5 to 10% based on the total molar amount of the aromatic dihydroxy compounds used.

Polycarbonates may be branched in a known manner, preferably by the incorporation of 0.05 to 2.0%, based on the molar amount of the aromatic dihydroxy compounds used, of compounds having a functionality of three or more, for example compounds having three or more phenolic groups.

Aromatic polyestercarbonates are known. Suitable such resins are disclosed in U.S. Pat. Nos. 4,334,053: 6,566,428 incorporated herein by reference and in CA1173998.

Aromatic dicarboxylic acid dihalides for the preparation of aromatic polyester carbonates include diacid dichlorides of isophthalic acid, terephthalic acid, diphenyl ether 4,4′-dicarboxylic acid and naphthalene-2,6-dicarboxylic acid. Particularly preferred are mixtures of diacid dichlorides of isophthalic acid and terephthalic acid in a ratio of from 1:20 to 20:1. Branching agents may also be used in the preparation of suitable polyestercarbonates, for example, carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of 0.01 to 1.0 mol. % (based on dicarboxylic acid dichlorides used), or phenols having a functionality of three or more, such as phloroglucinol, 4,6-dimethyl-2,4,6-tri-(4-hydroxyphenyl)-heptene-2,4,4-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxy-triphenyl)-methyl]-benzene, in amounts of from 0.01 to 1.0 mol. %, based on diphenols used. Phenolic branching agents can be placed in the reaction vessel with the diphenols, acid chloride branching agents may be introduced together with the acid dichlorides.

The content of carbonate structural units in the polyestercarbonates may preferably be up to 99 mol. %, more preferably up to 80 mol. %, most preferably up to 50 mol. %, based on the sum of ester groups and carbonate groups. Both the esters and the carbonates contained in the polyestercarbonates may be present in the polycondensation product in the form of blocks or in a randomly distributed manner.

The preferred aromatic polycarbonates have weight-average molecular weights (measured by gel permeation chromatography) of at least 25,000, more preferably at least 26,000. Preferably, these have maximum weight-average molecular weight of 80,000, more preferably up to 70,000, most preferably up to 50,000 g/mol.

The aromatic polycarbonate may preferably be present in the inventive thermoplastic molding compositions in an amount of 25 to 95 pbw, more preferably 40 to 80 pbw based on the weight of the composition.

### Impact Modifier

The graft (co)polymer suitable in the context of the invention has a core/shell structure and may preferably be obtained by graft polymerizing alkyl(meth)acrylate and optionally a copolymerizable vinyl monomer onto a composite rubber core. The composite rubber core that includes interpenetrated and inseparable interpenetrating network (IPN) type polymer is characterized by having a glass transition temperature preferably below 0° C., more preferably below −20° C., most preferably below −40° C.

The preferred core is a polysiloxane-alkyl(meth)acrylate interpenetrating network (IPN) type polymer that contains polysiloxane and butylacrylate. The shell is a rigid phase, preferably polymerized of methylmethacrylate. The weight ratio of polysiloxane/alkyl(meth)acrylate/rigid shell is 5-90/10-95/5-60.

The rubber core has median particle size (d₅₀ value) of preferably 0.05 to 5 micron, more preferably 0.1 to 2 microns, most preferably 0.1 to 1 micron. The median value may be determined by ultracentrifuge measurement (W. Scholtan, H. Lange, Kolloid, Z. and Z. Polymere 250 (1972), 782-1796).

The polyorganosiloxane component in the silicone acrylate composite rubber may be prepared by reacting an organosiloxane and a multifunctional crosslinking agent in an emulsion polymerization process. It is also possible to insert graft-active sites into the rubber by addition of suitable unsaturated organosiloxanes.

The organosiloxane may preferably be cyclic with the ring structures preferably containing from 3 to 6 Si atoms. Examples include hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, which may be used alone or in a mixture of 2 or more such compounds. The organosiloxane component is preferably present in the silicone acrylate rubber in an amount of at least 5%, more preferably at least 10%, based on weight of the silicone acrylate rubber.

Suitable crosslinking agents are tri- or tetra-functional silane compounds. Preferred examples include trimethoxymethylsilane, triethoxyphenylsilane, tetramethoxysilane, tetraethoxysilane, tetra-n-propoxysilane, tetrabutoxysilane.

Graft-active sites may be included into the polyorganosiloxane component of the silicone acrylate rubber by incorporating a compound conforming to any of the following structures:

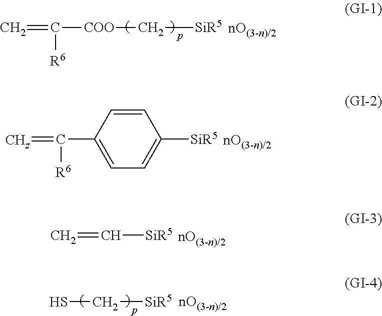

wherein
R⁵ denotes methyl, ethyl, propyl or phenyl,
R⁶ denotes hydrogen or methyl,
n denotes 0, 1 or 2, and
p denotes 1 to 6.

(Meth)acryloyloxysilane is a preferred compound for forming the structure (GI-1). Preferred (meth)acryloyloxysilanes include β-methacryloyloxyethyl-dimethoxy-methyl-silane, γ-methacryloyl-oxy-propylmethoxy-dimethyl-silane, γ-methacryloyloxypropyl-dimethoxy-methyl-silane, γ-methacryloyloxypropyl-trimethoxy-silane, γ-methacryloyloxy-propyl-ethoxy-diethyl-silane, γ-methacryloyloxypropyl-diethoxy-methyl-silane, γ-methacryloyloxy-butyl-diethoxy-methyl-silane.

Vinylsiloxanes, especially tetramethyl-tetravinyl-cyclotetrasiloxane, are suitable for forming the structure GI-2.

p-Vinylphenyl-dimethoxy-methylsilane, for example, is suitable for forming structure GI-3. γ-Mercaptopropyldimethoxy-methylsilane, γ-mercaptopropylmethoxy-dimethylsilane, γ-mercaptopropyl-diethoxymethylsilane, etc. are suitable for forming structure (GI-4).

The amount of these compounds is preferably up to 10%, more preferably 0.5 to 5.0% (based on the weight of polyorganosiloxane).

The acrylate component in the silicone acrylate composite rubber may be prepared from alkyl (meth)acrylates, crosslinkers and graft-active monomer units.

Examples of preferred alkyl (meth)acrylates include alkyl acrylates, such as methyl acrylate, ethyl acrylate, n-propyl acrylate, n-butyl acrylate, 2-ethylhexyl acrylate, and alkyl methacrylates, such as hexyl methacrylate, 2-ethylhexyl methacrylate, n-lauryl methacrylate. N-butyl acrylate is particularly preferred.

Multifunctional compounds may be used as crosslinkers. Examples include ethylene glycol dimethacrylate, propylene glycol dimethacrylate, 1,3-butylene glycol dimethacrylate and 1,4-butylene glycol dimethacrylate.

The following compounds individually or in mixtures may be used for inserting graft-active sites: allyl methacrylate, triallyl cyanurate, triallyl isocyanurate, allyl methacrylate. Allyl methacrylate may also act as a crosslinking agent. These compounds may preferably be used in amounts of 0.1 to 20%, based on the weight of acrylate rubber component.

Methods of producing the silicone acrylate composite rubbers which are preferably used in the compositions according to the invention, and their grafting with monomers, are described, for example, in U.S. Pat. Nos. 4,888,388 and 4,963,619 both of which are incorporated herein by reference.

The graft polymerization onto the graft base (herein C.1) may be carried out in suspension, dispersion or emulsion. Continuous or discontinuous emulsion polymerization is preferred. The graft polymerization is carried out with free-radical initiators (e.g. peroxides, azo compounds, hydroperoxides, persulfates, perphosphates) and optionally using anionic emulsifiers, e.g. carboxonium salts, sulfonic acid salts or organic sulfates.

The graft shell (C.2) may be formed of a mixture of
C.2.1: preferably 0 to 80%, more preferably 0 to 50%, most preferably 0 to 25% (based on the weight of the graft shell), of vinyl aromatic compounds or ring-substituted vinyl aromatic compounds (e.g. styrene, α-methylstyrene, p-methylstyrene), vinyl cyanides (e.g. acrylonitrile and methacrylonitrile), and
C.2.2: preferably 100 to 20%, more preferably 100 to 50%, most preferably 100 to 75% (based on the weight of the graft shell) of at least one monomer selected from the group consisting of (meth)acrylic acid (C₁-C₈)-alkyl esters (e.g. methyl methacrylate, n-butyl acrylate, tert.-butyl acrylate) and derivatives (e.g. anhydrides and imides) of unsaturated carboxylic acids (e.g. maleic anhydride and N-phenyl maleimide).

The preferred graft shell includes one or more (meth)acrylic acid (C₁-C₈)-alkyl esters, especially methyl methacrylate.

The impact modifiers (core-shell graft copolymers) useful in the present invention are coagulated with one or more salts of metals in the first or second column in the Periodic Table of the Elements (e.g., lithium, sodium, potassium, rubidium, cesium, francium, beryllium, magnesium, calcium, strontium, barium and radium). The present inventor has found that metals of these salts unexpectedly provide the resultant thermoplastic compositions with better hydrolytic stability over comparable thermoplastic compositions in which the impact modifiers have been coagulated with salts of other metals, such as aluminum.

### Polyalkylene Terephthalate

The optional polyalkylene terephthalates suitable in the present invention include homo-polymeric and copolymeric resins, the molecular structure of which include at least one bond derived from a carboxylic acid, preferably excluding linkages'derived from carbonic acid. These are known resins and may be prepared through condensation or ester interchange polymerization of the diol component with the diacid according to known methods. Examples are esters derived from the condensation of a cyclohexanedimethanol with an ethylene glycol with a terephthalic acid or with a combination of terephthalic acid and isophthalic acid. Also suitable are polyesters derived from the condensation of a cyclohexane-dimethanol with an ethylene glycol with a 1,4-cyclohexane-dicarboxylic acid. Suitable resins include poly(alkylene dicarboxylates), especially poly(ethylene terephthalate) (PET), poly(1,4-butylene terephthalate) (PBT), poly(trimethylene terephthalate) (PTT), poly(ethylene naphthalate) (PEN), poly(butylenes naphthalate) (PBN), poly(cyclohexanedimethanol terephthalate) (PCT), poly(cyclohexanedimethanol-co-ethylene terephthalate) (PETG or PCTG), and poly(1,4-cyclohexanedimethyl-1,4-cyclohexanedicarboxylate) (PCCD).

U.S. Pat. Nos. 2,465,319; 3,953,394 and 3,047,539, all incorporated herein by reference, disclose suitable methods for preparing such resins. The suitable polyalkylene terephthalates are characterized by an intrinsic viscosity of at least 0.2 and preferably about at least 0.4 deciliter/gram as measured by the relative viscosity of an 8% solution in orthochlorophenol at about 25° C. The upper limit is not critical but it generally does not exceed about 2.5 deciliters/gram. Especially preferred polyalkylene terephthalates are those with an intrinsic viscosity in the range of 0.4 to 1.3 deciliter/gram.

The alkylene units of the polyalkylene terephthalates which are suitable for use in the present invention contain from 2 to 5, preferably 2 to 4 carbon atoms. Polybutylene terephthalate (prepared from 1,4-butanediol) and polyethylene terephthalate are the preferred polyalkylene terephthalates for use in the present invention. Other suitable polyalkylene terephthalates include polypropylene terephthalate, polyisobutylene terephthalate, polypentyl terephthalate, polyisopentyl terephthalate, and polyneopentyl terephthalate. The alkylene units may be straight chains or branched chains.

The preferred polyalkylene terephthalates may contain, in addition to terephthalic acid groups, up to 20 mol % of groups from other aromatic dicarboxylic acids with 8 to 14 carbon atoms or aliphatic dicarboxylic acids with 4 to 12 carbon atoms, such as groups from phthalic acid, isophthalic acid, naphthalene-2,6-dicarboxylic acid, 4,4′-di-phenyl-dicarboxylic acid, succinic, adipic, sebacic, azelaic acids or cyclohexanediacetic acid.

The preferred polyalkylene terephthalates may contain, in addition to ethylene glycol or butanediol-1,4-groups, up to 20 mol % of other aliphatic diols with 3 to 12 carbon atoms or cylcoaliphatic diols with 6 to 21 carbon atoms, e.g. groups from propanediol-1,3,2-ethylpropanediol-1,3, neopentyl glycol, pentanediol-1,5, hexanediol-1,6, cyclohexane-dimethanol-1,4,3-methylpentanediol-2,4,2-methyl-pentanediol-2,4,2,2,4-trimethylpentanediol-1,3, and -1,6,2-ethylhexanediol-1,3,2,2-diethyl-propanediol-1,3, hexanediol-2,5,1,4-di-(β-hydroxyethoxy)-benzene, 2,2-bis-(4-hydroxycyclohexyl)-propane, 2,4-dihydroxy-1,1,3,3-tetra-methyl-cyclobutane, 2,2-bis-(3-β-hydroxyethoxyphenyl)-propane and 2,2-bis-(4-hydroxypropoxyphenyl)-propane (DE-OS 24 07 674, 24 07 776, 27 15 932).

The polyalkylene terephthalates may be branched by incorporating small amounts of 3- or 4-hydric alcohols or 3- or 4-basic carboxylic acids, such as are described, for example, in DE-OS 1,900,270 and U.S. Pat. No. 3,692,744. Examples of preferred branching agents include trimesic acid, trimellitic acid, trimethylol-ethane and -propane and pentaerythritol. Preferably, no more than 1 mol % of branching agent, with respect to the acid component, is used.

Polyalkylene terephthalates prepared solely from terephthalic acid and its reactive derivatives (e.g. its diallyl esters) and ethylene glycol and/or butanediol-1,4 (polyethyleneterephthalate and polybutylene-terephthalate) and mixtures of these polyalkylene terephthalates are particularly preferred. Copolyesters prepared from at least two of the acid components mentioned above and/or at least two of the alcohol components mentioned above are also preferred. Polyalkylene-terephthalates, poly(ethylene glycol/butanediol-1,4)-terephthalates being particularly preferred copolyesters.

Suitable polyalkylene terephthalates have been disclosed in U.S. Pat. Nos. 4,267,096; 4,786,692; 4,352,907; 4,391,954; 4,125,571; 4,125,572; 4,188,314 and 5,407,994 the disclosures of which are incorporated herein by reference.

The polyalkylene terephthalate may optionally be present in the inventive thermoplastic molding compositions in an amount of up to 75 pbw, preferably 20 to 60 pbw, based on the weight of the composition.

The inventive composition may further include additives that are known for their function in the context of thermoplastic compositions that contain polycarbonates or polyalkylene terephthalate. These include any one or more of lubricants, mold release agents, for example pentaerythritol tetrastearate, nucleating agents, antistatic agents, thermal stabilizers, light stabilizers, hydrolytic stabilizers, fillers and reinforcing agents, colorants or pigments, flame retarding agents and drip suppressants.

Conventional equipment and conventional procedures may be used in the preparation of the inventive composition. The inventive composition may be used to produce moldings of any kind by thermoplastic processes such as injection molding, extrusion and blow molding methods.

### EXAMPLES

The present invention is further illustrated, but is not to be limited, by the following examples. All quantities given in “parts” and “percents” are understood to be by weight, unless otherwise indicated.

The following materials were used in producing the inventive compositions:
Polycarbonate A a homopolycarbonate based on bisphenol-A, having a melt flow rate of about 13 gm/10 min. (300° C.-1200 g load) per ASTM D-1238 and commercially available as MAKROLON 2608 from Bayer MaterialScience;
Polycarbonate B a bisphenol-A based, linear homopolycarbonate having melt flow rate of about 4 g/10 min. (at 300° C.-1200 g load) per ASTM D 1238 and commercially available as MAKROLON 3208 from Bayer MaterialScience;
Impact Modifier A poly(organosiloxane/acrylate) based composite rubber graft copolymer, the core is composite rubber comprised of polysiloxane (siloxane) and polybutyl acrylate (BA) and the shell is comprised of polymethyl methacrylate (MMA), with a weight ratio of siloxane/BA/MMA of about 10/80/10;
Impact Modifier B poly(organosiloxane/acrylate) based composite rubber graft copolymer, the core is composite rubber comprised of polysiloxane (siloxane) and polybutyl acrylate (BA) and the shell is comprised of polymethyl methacrylate (MMA), with a weight ratio of siloxane/BA/MMA of about 10/80/10;
PET A a polyethylene terephthalate resin having an intrinsic viscosity of 0.94;
PET B a polyethylene terephthalate resin having an intrinsic viscosity of 0.59; and
PIGMENT a carbon black commercially available as Black Pearls 800, from Cabot Corp.

### Examples 1-8

In the preparation of exemplified compositions, the components and additives given below in the tables were melt compounded in a twin screw extruder ZSK 30 (temperature profile 120 to 255° C.). Impact Modifier A was coagulated with a salt of aluminum, whereas Impact Modifier B was coagulated with a salt of calcium. The pellets obtained were dried in a forced-air convection oven at 110-120° C. for 4 to 6 hours. Parts were injection molded (melt temperature 265 to 285° C., mold temperature about 75° C.

Melt flow rate was determined according to ASTM D-1238. The determination of Izod impact strength was carried out using specimens ⅛″ in thickness and in accordance with ASTM D-256.

TABLE I

| | | Ex. C1 | Ex. C2 | Ex. 3 | Ex. 4 |
|---|---|---|---|---|---|
| Component | | | | | |
| Polycarbonate (lbs.) | | 9.5 | 9 | 9.5 | 9 |
| Impact Modifier A (lbs.) | | 0.5 | 1 | | |
| Impact Modifier B (lbs.) | | | | 0.5 | 1 |
| Rheology Testing | | | | | |
| MVR @ 300° C./1.2 kg load (cm³/10 min) | | 8.78 | 6.75 | 9.95 | 8.37 |
| MVR @ 300° C./1.2 kg load - 1 Day @ | | 11.57 | 10.68 | 10.37 | 8.56 |
| 95° C./100% Relative Humidity (cm³/10 min) | | | | | |
| MVR @ 300° C./1.2 kg load - 3 Days @ | | 17.96 | 23.06 | 10.84 | 9.1 |
| 95° C./100% Relative Humidity (cm³/10 min) | | | | | |
| MVR @ 300° C./1.2 kg load - 5 Days @ | | 23.96 | 41.02 | 10.79 | 9.25 |
| 95° C./100% Relative Humidity (cm³/10 min) | | | | | |
| MVR @ 300° C./1.2 kg load - 7 Days @ | | 31.43 | 63.52 | 11.74 | 9.46 |
| 95° C./100% Relative Humidity (cm³/10 min) | | | | | |
| % Change | 1 Day | 31.78 | 58.22 | 4.22 | 2.27 |
| | 3 Days | 104.56 | 241.63 | 8.94 | 8.72 |
| | 5 Days | 172.89 | 507.7 | 8.44 | 10.51 |
| | 7 Days | 257.97 | 841.04 | 17.99 | 13.02 |
| Impact Testing | | | | | |
| ⅛″ Notched Izod @ 23° C. (ft · lbf/in) | | 15.45 | 13.44 | 15.72 | 14.13 |
| Break type | | all partials | all partials | all partials | all partials |
| ⅛″ Notched Izod @ 23° C. - 1 Day @ | | 12.30 | 10.47 | 12.12 | 13.36 |
| 95° C./100% Relative Humidity (ft · lbf/in) | | | | | |
| Break type | | all partials | all partials | all partials | all partials |
| ⅛″ Notched Izod @ 23° C. - 3 Days @ | | 10.42 | 9.28 | 11.62 | 11.92 |
| 95° C./100% Relative Humidity (ft · lbf/in) | | | | | |
| Break type | | all partials | all partials | all partials | all partials |
| ⅛″ Notched Izod @ 23° C. - 5 Days @ | | 10.85 | 8.23 | 11.51 | 11.17 |
| 95° C./100% Relative Humidity (ft · lbf/in) | | | | | |
| Break type | | all partials | all partials | all partials | all partials |
| ⅛″ Notched Izod @ 23° C. - 7 Days @ | | 8.05 | 6.12 | 10.72 | 11.91 |
| 95° C./100% Relative Humidity (ft · lbf/in) | | | | | |
| Break type | | all partials | all partials | all partials | all partials |
| % Change | 1 Day | −20.40 | −22.07 | −22.86 | −5.45 |
| | 3 Days | −32.54 | −30.95 | −26.09 | −15.63 |
| | 5 Days | −29.77 | −38.79 | −26.78 | −20.92 |
| | 7 Days | −47.89 | −54.46 | −31.80 | −15.73 |

TABLE II

| | Ex. C5 | Ex. 6 | Ex. C7 | Ex. 8 |
|---|---|---|---|---|
| Component | | | | |
| Polycarbonate A | 68.66 | 68.66 | | |
| PET B | 24.88 | 24.88 | | |
| Impact Modifier A | 5.97 | | 14.93 | |
| Polycarbonate B | | | 33.83 | 33.83 |
| PET A | | | 50.75 | 50.75 |
| Impact Modifier B | | 5.97 | | 14.93 |
| Pigment | 0.4975 | 0.4975 | 0.4975 | 0.4975 |
| Rheology Testing | | | | |
| MVR @ 265° C./5 kg load (cm³/10 min) | 24.89 | 21.97 | 16.91 | 13.34 |
| MVR @ 265° C./5 kg load - 1 Day @ | 29.69 | 24.90 | 44.21 | 22.98 |
| 95° C./100% Relative Humidity (cm³/10 min) | | | | |
| MVR @ 265° C./5 kg load - 3 Days @ | 39.31 | 32.49 | 188.20 | 36.76 |
| 95° C./100% Relative Humidity (cm³/10 min) | | | | |
| MVR @ 265° C./5 kg load - 5 Days @ | 61.00 | 42.70 | 404.17 | 55.19 |
| 95° C./100% Relative Humidity (cm³/10 min) | | | | |
| MVR @ 265° C./5 kg load - 7 Days @ | 71.04 | 48.00 | 928.63 | 95.94 |
| 95° C./100% Relative Humidity (cm³/10 min) | | | | |
| Impact Testing | | | | |
| ⅛″ Notched Izod @ 23° C. (ft · lbf/in) | 16.32 | 16.58 | 15.72 | 16.89 |
| ⅛″ Notched Izod @ 23° C. - 1 Day @ | 2.58 | 13.60 | 3.10 | 4.13 |
| 95° C./100% Relative Humidity (ft · lbf/in) | | | | |
| ⅛″ Notched Izod @ 23° C. - 3 Days @ | 1.72 | 11.27 | 0.58 | 3.13 |
| 95° C./100% Relative Humidity (ft · lbf/in) | | | | |
| ⅛″ Notched Izod @ 23° C. - 5 Days @ | 0.85 | 3.29 | 0.31 | 2.78 |
| 95° C./100% Relative Humidity (ft · lbf/in) | | | | |
| ⅛″ Notched Izod @ 23° C. - 7 Days @ | 0.67 | 2.16 | 0.28 | 1.85 |
| 95° C./100% Relative Humidity (ft · lbf/in) | | | | |

As can be appreciated by reference to Tables I and II, the examples demonstrate that rubber impact modifiers coagulated using a salt of metal elements in the first or second column in the Periodic Table (i.e., calcium) offer much better hydrolytic stability in polycarbonate or polycarbonate blends as compared to those modifiers coagulated using salt of another metal, such as aluminum.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A thermoplastic molding composition comprising
(a) an aromatic polycarbonate; and
(b) a core-shell graft copolymer which is coagulated with a salt of a metal element selected from the group consisting of lithium, sodium, potassium, rubidium, cesium, francium, beryllium, magnesium, calcium, strontium, barium and radium,
(c) optionally, a polyalkylene terephthalate,
wherein the thermoplastic molding composition exhibits improved hydrolytic stability over a comparable thermoplastic molding composition produced with a core shell graft copolymer coagulated with a salt of a metal element other than lithium, sodium, potassium, rubidium, cesium, francium, beryllium, magnesium, calcium, strontium, barium and radium.

2. The composition according to claim 1, wherein the aromatic polycarbonate is present in an amount of about 25 to about 99 pbw and the core-shell graft copolymer is present in an amount of about 1 to about 40 percent relative to the total weight of the thermoplastic composition.

3. The composition according to claim 1, wherein the aromatic polycarbonate is present in an amount of about 40 to about 80 pbw and the core-shell graft copolymer is present in an amount of about 5 to about 20 percent relative to the total weight of the thermoplastic composition.

4. The composition according to claim 1, wherein the polyalkylene terephthalate is present in an amount of up to about 75 pbw.

5. The composition according to claim 1, wherein the polyalkylene terephthalate is present in an amount of about 20 to about 60 pbw.

6. The composition according to claim 1, wherein the polyalkylene terephthalate is polyethylene terephthalate.

7. The composition according to claim 1, wherein the core-shell graft copolymer is coagulated with a salt of calcium.

8. A molded article prepared by molding the thermoplastic resin composition according to claim 1.

9. The molded article according to claim 8, wherein the article comprises a housing for electric appliance or vehicle parts.

10. The molded article according to claim 8, wherein the article comprises a battery housing.

11. A process for the production of a thermoplastic molding composition having improved hydrolytic stability, the process comprising combining:
(a) an aromatic polycarbonate; and
(b) a core-shell graft copolymer which is coagulated with a salt of a metal element selected from the group consisting of lithium, sodium, potassium, rubidium, cesium, francium, beryllium, magnesium, calcium, strontium, barium and radium,
(c) optionally, a polyalkylene terephthalate,
wherein the improved hydrolytic stability is over a comparable thermoplastic molding composition produced with a core shell graft copolymer coagulated with a salt of a metal element other than lithium, sodium, potassium, rubidium, cesium, francium, beryllium, magnesium, calcium, strontium, barium and radium.

12. The process according to claim 11, wherein the aromatic polycarbonate is present in an amount of about 25 to about 99 pbw and the core-shell graft copolymer is present in an amount of about 1 to about 40 percent relative to the total weight of the thermoplastic composition.

13. The process according to claim 11, wherein the aromatic polycarbonate is present in an amount of about 40 to about 80 pbw and the core-shell graft copolymer is present in an amount of about 5 to about 20 percent relative to the total weight of the thermoplastic composition.

14. The process according to claim 11, wherein the polyalkylene terephthalate is present in an amount of up to about 75 pbw.

15. The process according to claim 11, wherein the polyalkylene terephthalate is present in an amount of about 20 to about 60 pbw.

16. The process according to claim 11, wherein the polyalkylene terephthalate is polyethylene terephthalate.

17. The process according to claim 11, wherein the core-shell graft copolymer is coagulated with a salt of calcium.

18. A molded article prepared by molding the thermoplastic resin composition made according to the process of claim 11.

19. The molded article according to claim 18, wherein the article comprises a housing for electric appliance or vehicle parts.

20. The molded article according to claim 18, wherein the article comprises a battery housing.
